(19) United States
(12) Patent Application Publication
(10) Pub. No.: US 2006/0066066 A1
(43) Pub. Date: Mar. 30, 2006

(54) Child kickboard

(76) Inventor: Cheol Wang Lim, Shaha-Gu (KR)

Correspondence Address: ST. ONGE STEWARD JOHNSTON & REENS, LLC, 986 BEDFORD STREET, STAMFORD, CT, 06905-5619, US

(21) Appl. No.: 10/948,862

(22) Filed: Sep. 24, 2004

(51) Int. Cl. B62M 1/00

(52) U.S. Cl. 280/87.041

(57) ABSTRACT

Disclosed is a direction indicator interposed between a front wheel and a handle bar for controlling a rotating direction of the front wheel and operated in cooperation with the rotating direction of the front wheel, so that others can visibly recognize the change of traveling direction of the running kickboard. The kickboard includes a board, front and rear wheels installed to a front and rear of the board, and a handle bar coupled to a bracket supporting the front wheel for controlling a rotating direction of the front wheel. The kickboard further includes a direction indicator installed between the front wheel and the handle bar; in which the direction indicator is provided at a bottom surface thereof with a cut portion to receive the bracket, and the cut portion has bent side plates each contacted with sides of the bracket.

### FIELD OF THE INVENTION

The present invention relates to a child kickboard, and more particularly, to a child kickboard including a direction indicator interposed between a front wheel and a handle bar for controlling a rotating direction of the front wheel and operated in cooperation with the rotating direction of the front wheel.

### BACKGROUND OF THE RELATED ART

In general, a child kickboard includes a board, front and rear wheels installed to a front and rear of the board, and a handle bar coupled to a bracket supporting the front wheel for controlling a rotating direction of the front wheel.

The kickboard can rapidly move a short distance, with one foot of a user putting on the board, and the other foot kicking away a ground. The kickboard has some advantages of easy portability and usage. In addition, the kickboard can be folded, if necessary.

However, since the kickboard is not provided with a separate means for indicating the change of traveling direction, others cannot recognize the change of the traveling direction of the kickboard, so that they may collide with the kickboard.

### SUMMARY OF THE INVENTION

Accordingly, the present invention is directed to a kickboard that substantially obviates one or more problems due to limitations and disadvantages of the related art.

An object of the present invention is to provide a child kickboard including a direction indicator interposed between a front wheel and a handle bar for controlling a rotating direction of the front wheel and operated in cooperation with the rotating direction of the front wheel, so that others can visibly recognize the change of traveling direction of the running kickboard.

Another object of the present invention is to provide a kickboard including a direction indicator configured in various shapes to satisfy a child with an affinity and curiosity.

Still another object of the present invention is to provide a kickboard, of which a rotating angle of a handle bar is limited to a desired angle to prevent a child from falling.

Further another object of the present invention is to provide a kickboard including a direction indicator, in which during traveling, a child can put articles into a basket attached to a front of a handle bar.

To achieve the object and other advantages, according to one aspect of the present invention, there is provide a child kickboard including a board, front and rear wheels installed to a front and rear of the board, and a handle bar coupled to a bracket supporting the front wheel for controlling a rotating direction of the front wheel, the kickboard comprising: a direction indicator installed between the front wheel and the handle bar; in which the direction indicator is provided at a bottom surface thereof with a cut portion to receive the bracket, and the cut portion has bent side plates each contacted with sides of the bracket.

It is to be understood that both the foregoing general description and the following detailed description of the present invention are exemplary and explanatory and are intended to provide further explanation of the invention as claimed.

### BRIEF DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view of a child kickboard including a direction indicator according to one preferred embodiment of the present invention;

FIG. 2 is an exploded perspective view of the kickboard in FIG. 1;

FIG. 3 is a perspective view showing a direction indicator assembled to the kickboard according to the present invention;

FIG. 4 is a cross-sectional view taken along a line A-A in FIG. 3, showing an assembled state of a direction indicator and a kickboard;

FIG. 5 is a cross-sectional view taken along a line B-B in FIG. 4; and

FIGS. 6 and 7 are views showing a sequentially rotating state of the direction indicator according to operation of a handle bar.

### DETAILED DESCRIPTION OF PREFERRED EMBODIMENTS

A preferred embodiment according to the present invention will now be explained with reference to the accompanying drawings.

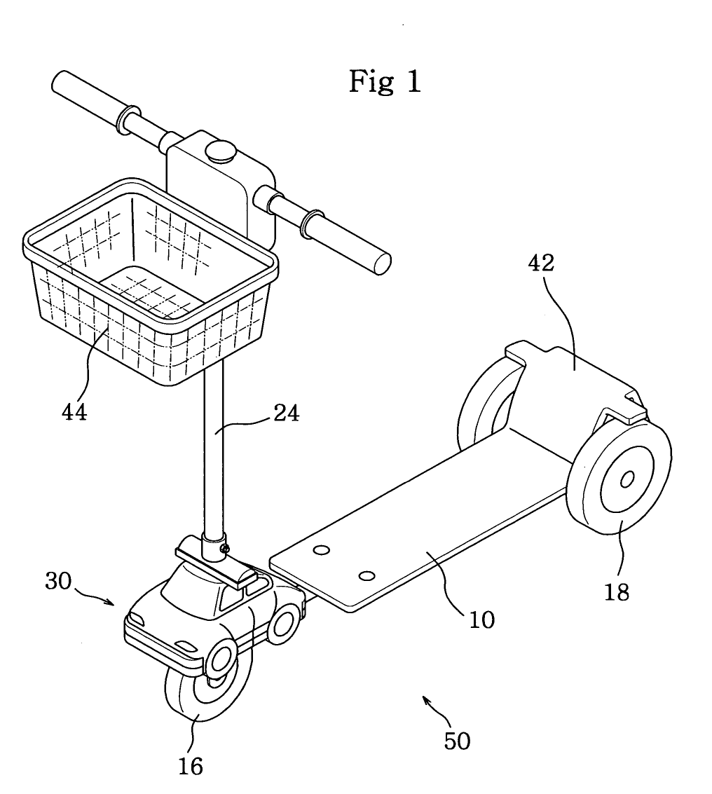

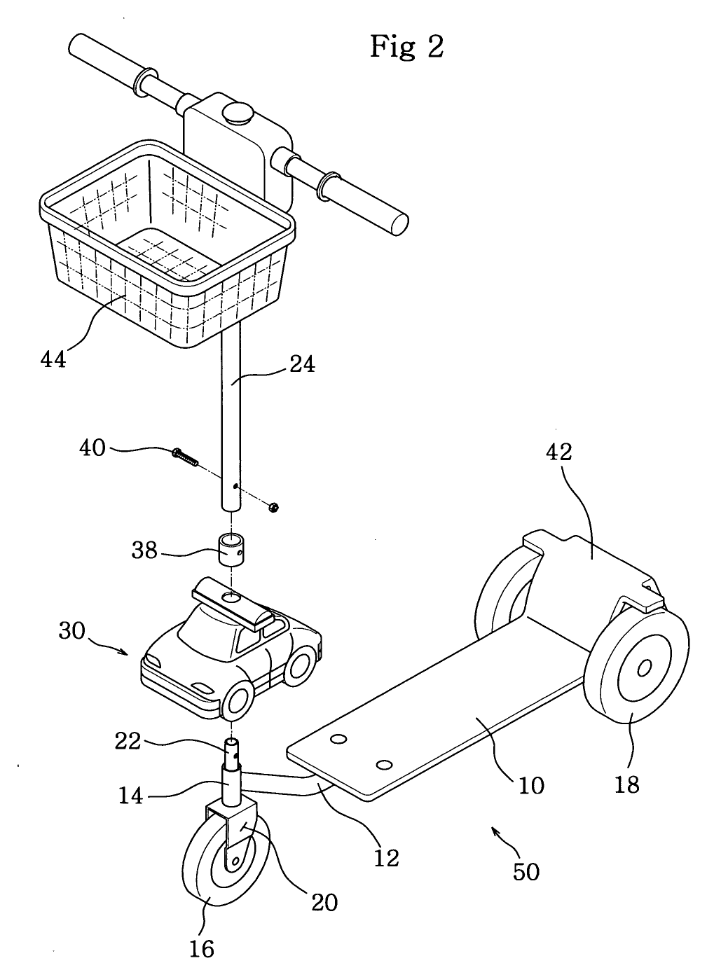

FIG. 1 is a perspective view of a child kickboard 50 including a direction indicator according to one preferred embodiment of the present invention, and FIG. 2 is an exploded perspective view of the kickboard 50 in FIG. 1. Referring to FIGS. 1 and 2, the kickboard 50 includes a board 12 functioning as a footboard, a supporting frame 10 for supporting the board 12, front and rear wheels 16 and 18 installed to a front and rear of the support frame 10, and a handle bar 24 coupled to the front wheel 16 for controlling a rotating direction of the front wheel 16.

The front wheel 16 is supported by a bracket 20 having a rotating shaft 22. The rotating shaft 22 passes through a coupling pipe 14 installed to the front of the support frame 12, and is fitted into the handle bar 24 and is fastened by a bolt 40. Therefore, the front wheel coupled to the handle bar 24 is easily rotated in left and right directions according to operation of the handle bar 24.

The direction indicator 30 is installed between the handle bar 24 and the front wheel 16, and is rotated in cooperation with the rotating direction of the front wheel 16, so as to indicate a person a traveling direction of the kickboard 50.

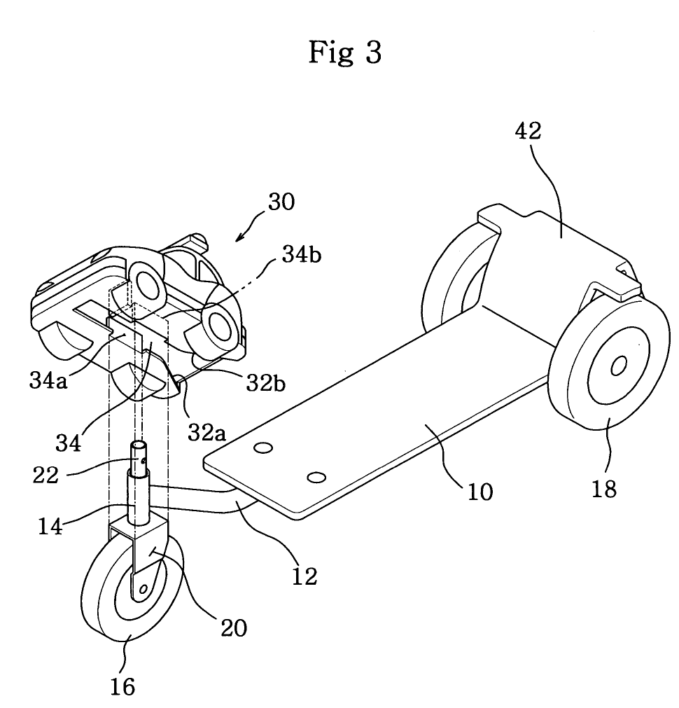

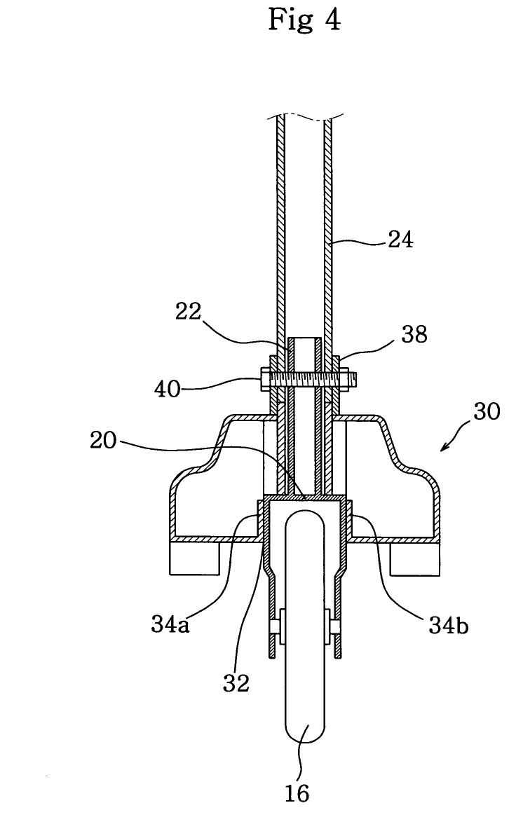

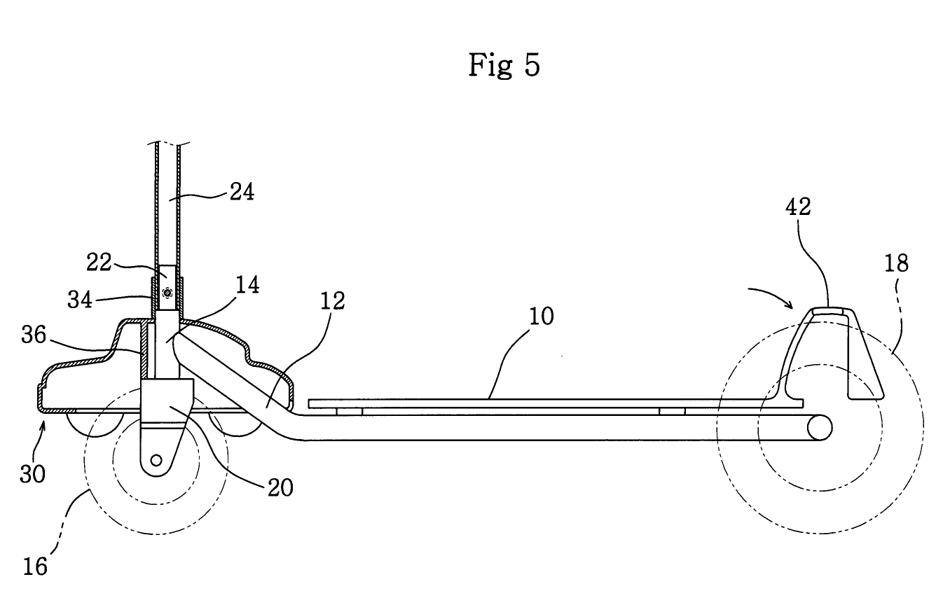

FIG. 3 is a perspective view showing the direction indicator assembled to the kickboard according to the present invention. FIG. 4 is a cross-sectional view taken along a line A-A in FIG. 3, showing an assembled state of a direction indicator and a kickboard. FIG. 5 is a cross-sectional view taken along a line B-B in FIG. 4.

Referring to FIGS. 3 to 5, the direction indicator 30 is provided at a bottom surface with a cut portion 32 to receive the bracket 20 supporting the front wheel 16. The cut portion 32 has bent side plates 34a and 34b each contacted with sides of the bracket 20. The direction indicator includes a locking member 36 mounted to an upper end of the bracket 20.

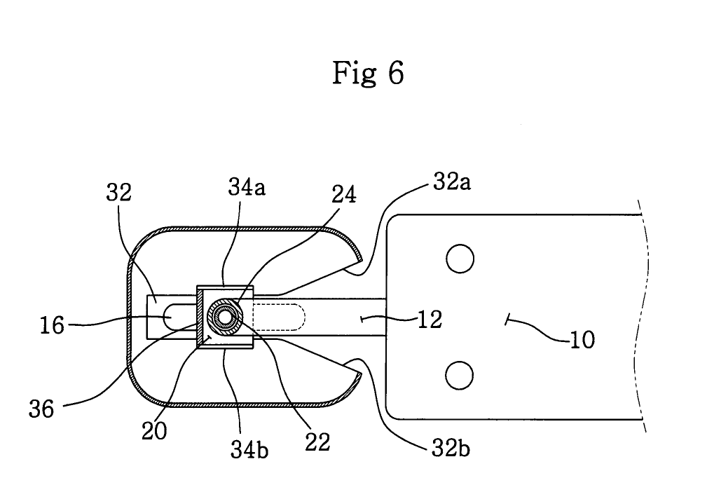

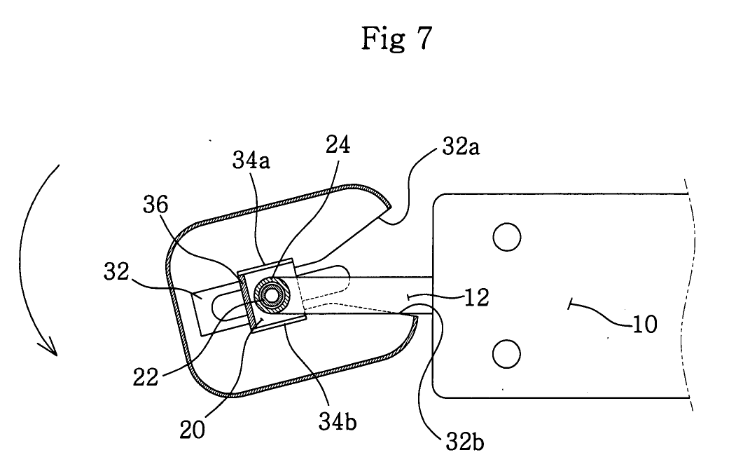

The direction indicator 30 is firmly mounted to the bracket 20 by means of the locking member 36. In particular, the direction indicator 20 is moved in left and right by the left and right movement of the front wheel 16 supported by the bracket 20 through the side plates 34a and 34b, the movement of which will be easily understood with reference to FIGS. 6 and 7.

As shown in FIGS. 6 and 7, when the traveling direction of the running kickboard 50 is changed (in the left direction in the figures), the bracket 20 coupled to the handle bar 24 is moved in the left direction by rotating the handle bar 24 in the left direction, thereby moving the front wheel 16 in the left direction. At this same time, the direction indicator 30 is also moved in the same direction as that of the bracket 20 through the side plates 34a and 34b contacted with both sides of the bracket 20. Accordingly, others can visibly recognize the change of the traveling direction of the running kickboard 50 through the rotating operation of the direction indicator 30. The direction indicator 30 has a toy vehicle as shown in the figures, but can be configured in various shapes (e.g., doll, animal toy, etc.) to satisfy the child with an affinity and curiosity. Preferably, the direction indicator 30 is detachably mounted between the handle bar 24 and the front wheel 16, such that it can be easily replaced with another direction indicator, if necessary.

The cut portion 32 formed at the bottom surface of the direction indicator 30 is provided at a rear portion thereof with inclined surfaces 32a and 32b gradually widened toward both sides of the cut portion. The inclined surfaces 32a and 32b are optionally contacted with the support frame 12 when the direction indicator 30 is rotated to regulate the rotary angle of the handle bar 24.

FIGS. 6 and 7 are views showing a sequentially rotating state of the direction indicator according to operation of the handle bar. Referring to FIGS. 6 and 7, when the direction indicator 30 is rotated by the operation of the handle bar 24, any one of the inclined surfaces 32a and 32b formed at the rear of the cut portion 32 is caught by the support frame 12, so that the direction indicator 30 is no more rotated. Therefore, the handle bar 24 associated with the direction indicator 30 can be rotated within a range of an inclined angle of the inclined surfaces 32 and 32b, so that it is possible to prevent a child from falling due to significantly large rotation.

A fixing tube 38 is installed to the upper end of the direction indicator 30 to fix the direction indicator 30, and is fitted into an outer periphery of the coupling tube 14 and fastened by a bolt 40.

The kickboard 10 also includes a brake plate 42 integrally formed with a rear portion of the kickboard 10. The brake plate 42 has a desired tension, and is selectively contacted with the rear wheel 18 to brake the kickboard 50 using a friction between the brake plate and the rear wheel.

The handle bar 24 may include at a front thereof a basket 44 for accommodating articles. During traveling, the child can put articles into the basket 44.

With the above description, according to a direction indicator rotated in cooperation with the operation of a front wheel is installed between the front wheel and a handle bar. Others can visibly recognize the change of traveling direction of the running kickboard through the rotating operation of the direction indicator. A rotating angle of the handle bar is properly adjusted to prevent a child from falling due to significantly large rotation. Also, during traveling, the child can put articles into a basket attached to the handle bar.

The forgoing embodiments are merely exemplary and are not to be construed as limiting the present invention. The present teachings can be readily applied to other types of apparatus. The description of the present invention is intended to be illustrative, and not to limit the scope of the claims. Many alternatives, modifications, and variations will be apparent to those skilled in the art.

What is claimed is:

1. A child kickboard including a board, front and rear wheels installed to a front and rear of the board, and a handle bar coupled to a bracket supporting the front wheel for controlling a rotating direction of the front wheel, the kickboard comprising:
a direction indicator installed between the front wheel and the handle bar;
in which the direction indicator is provided at a bottom surface thereof with a cut portion to receive the bracket, and the cut portion has bent side plates each contacted with sides of the bracket.

2. The child kickboard as claimed in claim 1, wherein the direction indicator includes a locking member mounted to an upper end of the bracket.

3. The child kickboard as claimed in claim 1, wherein the cut portion is provided with inclined surfaces at both sides of the cut portion.

4. The child kickboard as claimed in claim 1, wherein the handle bar includes at a front thereof a basket for accommodating articles
